(19) United States
(12) Patent Application Publication
(10) Pub. No.: US 2010/0004021 A1
(43) Pub. Date: Jan. 7, 2010

(54) Wireless Terminal, Wireless Communication System And Method for Connecting Wireless Terminal to Communication Network

(75) Inventor: Ching-Yu Lin, Hsinchu City (TW)

Correspondence Address: COVENANT IP CONSULTING CO., P.O. BOX 34-306 TAIPEI CITY, TAIPEI, 10499, TW

(73) Assignee: Qisda Corporation, Taoyuan (TW)

(21) Appl. No.: 12/497,553

(22) Filed: Jul. 3, 2009

(30) Foreign Application Priority Data
Jul. 4, 2008 (TW) 097125266

(51) Int. Cl. H04M 1/00; H04W 84/02

(52) U.S. Cl. 455/552.1; 370/338

(57) ABSTRACT

The invention provides a mobile terminal having a first network module for connecting to a wireless wide area network (WWAN) and a second network module for connecting to a wireless local area network (WLAN). The WWAN includes a plurality of first base stations. The WLAN includes a second base station. The second base station obtains service information related to the first base stations and sends the service information to the second network module. When the first network module is turned off and the second network module is turned on, the a mobile terminal is leaving the service area of the WLAN. The first network module turns on and chooses one of the first base stations to be a serving base station according to the saved service information for quickly accessing the WWAN.

### BACKGROUND OF THE INVENTION

1. Field of the Invention

The invention relates to a dual mode mobile terminal and, more particularly, to a connecting method for selectively connecting to a wireless wide area network and a wireless local network.

2. Description of the Prior Art

In recent years, new communication technologies are developed and customers can select different kinds of personal communication systems to use voice/data services. The communication systems are, for example, GSM/WCDMA/CDMA2000 wireless wide area networks (WWAN) and voice service over wireless local area networks (WLAN).

Fixed Mobile Convergence (FMC) is developed by integrating both WWAN and WLAN in one communication system. The connection of a FMC mobile terminal can be switched between WWAN and WLAN when the mobile terminal determines one of the networks is suitable for communicating. The mobile terminal having two wireless modules, for example, a GSM module and a WiFi module. When the signal level of the WLAN is above a first threshold, the mobile terminal accesses the WLAN through the WiFi module. When the mobile terminal is leaving the coverage of the WLAN and the signal level of WLAN drops below a second threshold, the mobile terminal switched to the WWAN and communicating through the GSM module.

However, when the mobile terminal turns the GSM module and the WiFi module on at the same time for selectively communicates the WWAN and the WLAN, it is power consuming. To overcome the above drawbacks, the GSM module is turned off and WiFi module turned on, when the mobile terminal only accesses the WLAN. Once the signal level received from the WLAN becomes low, the mobile terminal turns the GSM module on for connecting the WWAN for keeping the connection. The GSM module begins to scan the neighboring base stations. However, because of different communication environments, occasionally, it is possible that the GSM module needs a longer scanning/processing time that may cause some of the connections dropped, especially when the user is using the mobile terminal for voice communication.

In order to solve the aforesaid problems, this invention want to provide a method and a system to make the mobile terminal switches from the WLAN to the WWAN in time to avoid dropping or delaying the connections.

### SUMMARY OF THE INVENTION

It is therefore an object of the invention to provide a mobile terminal selectively connecting a wireless wide area network and a wireless local area network. The wireless local area network gathers the information of neighboring base stations from an access point. The mobile terminal receives the information when the mobile terminal connects the wireless local area network. The mobile terminal can skip some of the connection setup time when the mobile terminal starts to connect the wireless wide area network by using the information.

According to the invention, a mobile terminal is able to select one of a wireless wide area network (WWAN) or a wireless local area network (WLAN) for voice/data communicating. The WWAN, for example a GSM network, contains a plurality of the first base stations. Each coverage of the first base station is about 2 to 10 km in a normal GSM system. The WLAN contains at least one second base station for gathering a service information of the first base stations. The service information includes signal strength, channel information and base station identity codes of the first base stations. The service information is broadcasted by the first base stations. The second base station of WLAN can be an access point. In this invention, the access point has a GSM module for scanning the broadcasting information of the neighboring first base station. The access point transmits the information to the mobile terminal when the mobile terminal is connecting the access point.

The mobile terminal has a first network module and a second network module. The first network module, for example, is a GSM module for connecting the WWAN. The second network module, for example, is a WiFi module for connecting the second base station and receiving the service information from the WLAN;

In this invention, the coverage of the WWAN and the coverage of the second base station are overlapping. When the mobile terminal connects to the second base station in the coverage of the second base station, the first network module turns off and the second network module turns on. When the user uses the mobile terminal at his house, the mobile terminal connects the WLAN for communication services. When the user leaves out his house and carries the mobile terminal with him, the signal level of a transmitting signal of the second base station received by the mobile terminal becomes low. When the signal level of a transmitting signal is lower than a first threshold, the mobile terminal turns the first network module on and the first network module selects one of the first base stations as a serving base station according to the service information to connect the WWAN. In other words, some initial scanning procedures of the first network module are made by the second base station and recorded in the service information. The signal strength of the serving base station is the highest one among signal strength of the first base stations. As the first network module skips some initial scanning procedures that the access point made before, it may accelerate the connecting procedures for the first network module. When the user comes back to his house, the signal level of a transmitting signal from the second base station is higher than a second threshold, the first module turns off. The mobile terminal connects the second base station for further communicating.

It is still possible that the first wireless module fails to connect the serving base station by using the service information because of the environments rapidly changing. In that case, the first wireless module starts scanning the first base stations according to the channel information of the service information, i.e. scanning all channel information of the first base stations. In case, the first wireless module still fails to connect the serving base station, it needs to start a conventional connecting procedure.

This invention provide a method for a mobile terminal to select a serving base station of a wireless wide area network (WWAN) in a communication system. The communication system contains the wireless wide area network (WWAN) and a wireless local area network (WLAN) and the mobile terminal. The WWAN has a plurality of first base stations. The WLAN has a second base station for gathering a service information of the first base stations. The mobile terminal has a first wireless module for connecting the WWAN and a second wireless module for connecting the second base station. Normally, when the mobile terminal connects the WLAN, the second wireless module is on and the first wireless module is off. The steps of the method are: (a) turning the first wireless module on according to a first rule; (b) the second wireless module receiving the service information from the second base station; (c) the second wireless module transmitting the service information to the first wireless module; and (d) the first network module selecting one of the first base stations as a serving base station according to the service information to connect the WWAN.

In step (b), the second network module sends a requesting signal to the second base station. And then, the second base station gathers the service information of the first base station. The second base station sends the service information to the second network module. The service information contains signal strength, channel information and base station identity codes of the first base stations.

In case, the first wireless module failed to connect the serving base station by using the service information, the first wireless module starts scanning the first base stations according to the channel information of the service information.

The advantage and spirit of the invention may be understood by the following recitations together with the appended drawings.

### BRIEF DESCRIPTION OF THE APPENDED DRAWINGS

FIG. 1 is a functional block diagram illustrating the system contains the mobile terminal, WWAN and WLAN.

FIG. 2 is a flow diagram generally showing one embodiment of the method for the mobile terminal selecting a serving base station.

FIG. 3 is a flow diagram generally showing one embodiment for the mobile terminal receiving the service information from the second base station.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

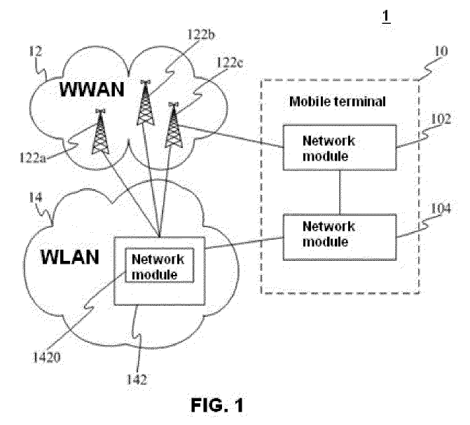

FIG. 1 illustrates a function block diagram of one embodiment of a communication system 1. The communication system 1 contains a mobile terminal 10, a wireless wide area network (WWAN) 12 and a wireless local network (WLAN) 14. The WWAN 12 can be GSM, GPRS, WCDMA or 4 G network based on LTE. The WLAN 14 can be WiMax, WiFi or Bluetooth network.

The WWAN 12 and The WLAN 14 can be integrated into a FMC (fixed-mobile convergence) system and the mobile terminal 10 is adapted for the FMC system accordingly. However the mobile terminal 10 can be a dual mode mobile terminal for using in the WLAN 14 and the WWAN 12 which are independent.

The WWAN 12 contains the first base stations 122a, 122b and 122c. The WLAN 14 contains a second base station 142. The second base station 142 can be an access point with a third network module 1420 for gathering the service information of the first base stations. The service information contains signal strength, channel information and base station identity codes of the first base stations. The third network module 1420 is a radio frequency receiver for demodulating/decoding the broadcasting signals of the first base stations to obtain the above service information.

The mobile terminal 10 contains a first wireless module 102 and a second wireless module 104. The first wireless module 102 can be selectively turning on and turning off for connecting the WWAN 12. The second wireless module 104 can accessing the WLAN 14 through the second base station 142 and receiving the service information from the second base station.

When the first wireless network module 102 turning off and the second wireless network 104 turning on, the mobile terminal 10 may turn on/off the first wireless network module 102 according a first rules. The first rules are, for example, detecting the signal level of the transmitting signal transmitted from the second base station 142 to the second wireless module 104 is smaller than a first predetermined threshold or the signal level of the transmitting signal is continuously smaller than a second predetermined threshold for a time period, turning on the first wireless network module 102. The first rules can also be the signal level of the transmitting signal from the second base station 142 to the second wireless module 104 is greater than a third predetermined threshold, turning off the first wireless network module 102 and accessing the second base station 142 by the second wireless network 104. It is also possible to build other new first rules, for example, the user can set a timer for turning on/off the first wireless network module 102 etc.

When the first wireless network module 102 turns on, the first wireless network module 102 selecting a serving base station from the base stations 122a, 122b and 122c according to the service information. In this embodiment, the third network module 1420 gathering the service information of the first base stations and determining the first base station being the serving base station with the strongest signal strength among the first base stations. The mobile terminal 10 can access the WWAN 12 by the serving base station 122c.

Alternatively, the first wireless network module 102 may also select a specific mobile phone operator according the Base Station Identity Code (BSIC) of the service information.

When the first wireless network module 102 fails to build up a connection to the serving base station by using the service information. The first wireless network module 102 can scan the frequency channels by using the service information. If it fails again, it may start an all channels scanning procedures.

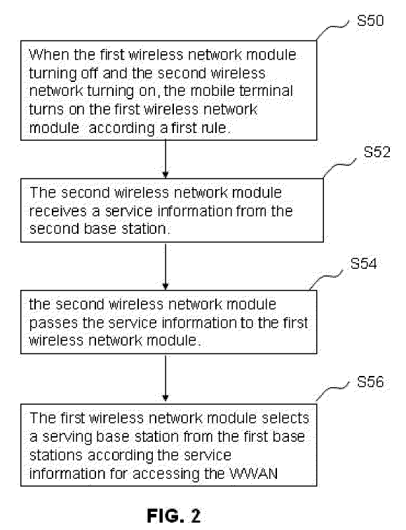

FIG. 2 illustrates a flow diagram showing one embodiment of the method for the mobile terminal selecting a serving base station. The method is adopted to the system shown on the FIG. 1. At block S50, when the first wireless network module turning off and the second wireless network turning on, the mobile terminal can turn on/off the first wireless network module according a first rule. The first rules is, for example, the transmitting signal transmitted from the second base station to the second wireless module is smaller than a first predetermined threshold, turning on the first wireless network module 102.

At block S52, the second wireless network module receives a service information from the second base station. The service information is related to the broadcasting information of the neighboring first base station. Block S52 may be processing before or after block S50. It is also possible that the second wireless network module continuously (or periodically) accesses the service information from the second base station. The service information contains signal strength, channel information and base station identity codes of the first base stations.

At block S54, the second wireless network module passes the service information to the first wireless network module. At block S56, the first wireless network module selects a serving base station from the first base stations according the service information for accessing the WWAN. In this embodiment, the second base station gathering the service information of the first base stations and determining one of the first base station being the serving base station with the strongest signal strength among the first base stations. Alternatively, the first wireless network module may also select a specific mobile phone operator according the Base Station Identity Code (BSIC) of the service information.

When the first wireless network module fails to build up a connection to the serving base station by using the service information. The first wireless network module can scan the frequency channels by using the service information. If it fails again, it may start an all channels scanning procedure.

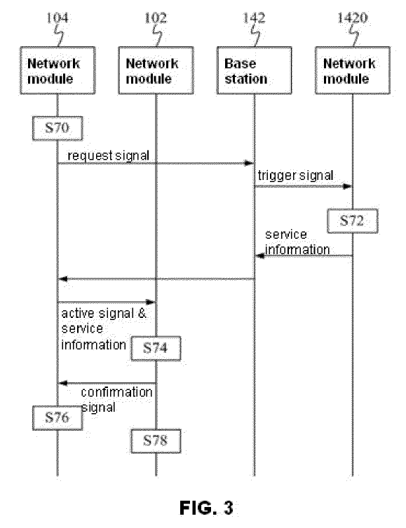

FIG. 3 illustrates a flow diagram showing one embodiment for the mobile terminal 10 selecting a serving base station. When the second wireless network module 104 find the rule is active, for example, the signal level of the transmitting signal from the second base station 142 to the second wireless module 104 is smaller than a first predetermined threshold, turning the first wireless network module 102 on. At block S70, the second wireless network module 104 start a procedure for waking up the first wireless network module 102.

In the mean time, the second wireless network module 104 transmitting a request signal to the second base station 142 according as the rule is active. The second base station 142 triggers the third wireless network module 1420 receiving the radio signals of the neighboring first base stations for gathering a service information. At block 72, the third wireless network module 1420 may continuously or periodically scan and store the service information.

When the third wireless network module 1420 gets the service information, the second base station sends the service information the second wireless network module 104. Then, the second wireless network module 104 passes the service information to the first wireless network module 102. At block S74, the first wireless network module 102 selects a serving base station from the first base stations according the service information.

When the first wireless network module 102 connects the serving base station and accesses the WWAN, the first wireless network module 102 sends an confirmation signal to the second wireless network module 104. At block S76, the second wireless network module 104 begins a switching procedure from the WLAN to WWAN, at block S78.

In this invention, no matter what status of the mobile terminal is, for example “call set up”, “idle” or even the mobile terminal is in a calling status, the mobile terminal can use this invention for switching the connecting from WLAN to WWAN.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A mobile terminal for selectively connecting to a wireless wide area network (WWAN) and a wireless local area network (WLAN), the WWAN having a plurality of first base stations, the WLAN having a second base station for gathering a service information of the first base stations, the mobile terminal comprising:
a first network module; and
a second network module for connecting the second base station and receiving the service information from the second base station;
wherein when the first network module turns off and the second network module turns on, the mobile terminal turns on the first network module according to a first rule, wherein when the first network module turns on, the first network module selects one of the first base stations as a serving base station according to the service information to connect the WWAN.

2. The mobile terminal of claim 1, wherein the first rule comprises: when the second module receives a transmitting signal from the second base station and a signal level of the transmitting signal is lower than a first threshold, the first module turns on.

3. The mobile terminal of claim 2, wherein the first rule further comprises: when the signal level of the transmitting signal is higher than a second threshold, the first module turns off.

4. The mobile terminal of claim 1, wherein the second base station further comprises a third wireless module for gathering the service information from the first base stations.

5. The mobile terminal of claim 1, wherein the service information comprises signal strength, channel information and base station identity codes of the first base stations.

6. The mobile terminal of claim 1, wherein when the first wireless module fails to connect the serving base station, the first wireless module scanning the first base stations according to the channel information of the service information.

7. The mobile terminal of claim 1, the service information comprising a first channel information and signal strength of a first signal of the serving base station, wherein the signal strength of a first signal is the highest one among signal strength of the first base stations.

8. The mobile terminal of claim 7, wherein when the first wireless module turns on, the first wireless module connects the serving base station with the first channel information.

9. A wireless communication system comprising:
a wireless wide area network (WWAN), comprising a plurality of first base stations;
a wireless local area network (WLAN), comprising a second base station for gathering a service information of the first base stations; and
a mobile terminal comprising a first wireless module and a second wireless module, the second wireless module for connecting the second base station and receiving the service information from the WLAN,
wherein when the first network module turns off and the second network module turns on, the mobile terminal turns on the first network module according to a first rule, wherein when the first network module turns on, the first network module selects one of the first base stations as a serving base station according to the service information to connect the WWAN.

10. The wireless communication system of claim 9, wherein the first rule comprises: when the second module receives a transmitting signal from the second base station and a signal level of the transmitting signal is lower than a first threshold, the first module turns on.

11. The wireless communication system of claim 10, wherein the first rule further comprises when the signal level of the transmitting signal is higher than a second threshold, the first module turns off.

12. The wireless communication system of claim 9, wherein the second base station further comprises a third wireless module for gathering the service information from the first base stations.

13. The wireless communication system of claim 9, wherein the service information comprises signal strength, channel information and base station identity codes of the first base stations.

14. The wireless communication system of claim 9, wherein when the first wireless module fails to connect the serving base station, the first wireless module scanning the first base stations according to the channel information of the service information.

15. The wireless communication system of claim 9, the service information comprising a first channel information and a signal strength of a first signal of the serving base station, wherein the signal strength of a first signal is the highest one among signal strength of the first base stations.

16. The mobile terminal of claim 15, wherein when the first wireless module turns on the first wireless module connects the serving base station with the first channel information.

17. A method for a mobile terminal selectively connecting to a wireless wide area network (WWAN) and a wireless local area network (WLAN), the WWAN having a plurality of first base stations, the WLAN having a second base station for gathering a service information of the first base stations, the mobile terminal comprising a first wireless module for connecting the WWAN and a second wireless module for connecting the second base station, when the second wireless module connecting the second base station, the first wireless module turning off, the method comprising:
turning the first wireless module on according to a first rule;
the mobile terminal receiving the service information from the second base station through the second wireless module; and
the first network module selecting one of the first base stations as a serving base station according to the service information to connect the WWAN

18. The method of claim 17, the method further comprising:
the second network module sending a requesting signal to the second base station;
the second base station gathering the service information of the first base station; and
the second base station sending the service information to the second network module.

19. The method of claim 17, the service information further comprising signal strength, channel information and base station identity codes of the first base stations, the method further comprising:
the first wireless module scanning the first base stations according to the channel information of the service information when the first wireless module failed to connect the serving base station,

20. The method of claim 17, wherein the first rule comprises: when the second module receives a transmitting signal from the second base station and a signal level of the transmitting signal is lower than a first threshold, the first module turns on
